(19) United States
(12) Patent Application Publication
(10) Pub. No.: US 2006/0167891 A1
(43) Pub. Date: Jul. 27, 2006

(54) Method and apparatus for redirecting transactions based on transaction response time policy in a distributed environment

(76) Inventors: Russell C. Blaisdell, Austin, TX (US); Bryan Christopher Chagoly, Austin, TX (US); Nduwuisi I. Emuchay, Austin, TX (US); Kirk Malcolm Sexton, Austin, TX (US)

Correspondence Address: IBM CORP (YA);C/O YEE & ASSOCIATES PC, P.O. BOX 802333, DALLAS, TX, 75380, US

(21) Appl. No.: 11/044,463

(22) Filed: Jan. 27, 2005

(51) Int. Cl. G06F 17/30

(52) U.S. Cl. 707/10

(57) ABSTRACT

A method, system, and computer program instructions for using existing performance monitoring solutions to detect performance issues in an enterprise, and providing and executing a corrective action on any server being monitored in the enterprise to correct the performance issue. When a management agent on a monitored server detects a threshold violation, the management agent sends a violation event to the management server. Upon receiving the violation event, the management server distributes a corrective action associated with the threshold violation to a set of defined management agents involved in the transaction. Each management agent then runs the corrective action to remedy the performance problem.

### RELATED APPLICATIONS

The present invention is related to the following application entitled, “Method and Apparatus for Exposing Monitoring Violations to the Monitored Application”, Ser. No. ______, attorney docket no. AUS920040755US1, filed on ______. The above related application is assigned to the same assignee, and incorporated herein by reference.

### BACKGROUND OF THE INVENTION

1. Technical Field

The present invention is directed to an improved data processing system. In particular, the present invention provides a method, apparatus, and computer program instructions for redirecting transactions based on transaction response time-policy in a distributed environment.

2. Description of Related Art

Performance monitoring is often used in optimizing the use of software in a system. A performance monitor is generally regarded as a facility incorporated into a processor to assist in analyzing selected characteristics of a system by determining a machine's state at a particular point in time. One method of monitoring system performance is to monitor the system using a transactional-based view. In this manner, the performance monitor may access the end-user experience by tracking the execution path of a transaction to locate where problems occur. Thus, the end user's experience is taken into account in determining if the system is providing the service needed. Another method of monitoring system performance is to monitor the system based on resources. For example, by monitoring central processing unit (CPU) usage and memory consumption, problem areas may be identified based on the amount of resources consumed by each process currently running in the system.

An example of a transaction monitoring system is Tivoli Monitoring for Transaction Performance™ (hereafter TMTP). TMTP is a centrally managed suite of software components that monitor the availability and performance of Web-based services and operating system applications. TMTP captures detailed transaction and application performance data for all electronic business transactions. With TMTP, every step of a customer transaction as it passes through an array of hosts, systems, application, Web and proxy servers, Web application servers, middleware, database management software, and legacy back-office software, may be monitored and performance characteristic data compiled and stored in a data repository for historical analysis and long-term planning. One way in which this data may be compiled in order to test the performance of a system is to simulate customer transactions and collect “what-if” performance data to help assess the health of electronic business components and configurations. TMTP provides prompt and automated notification of performance problems when they are detected.

With TMTP, an electronic business owner may effectively measure how users experience the electronic business under different conditions and at different times. Most importantly, the electronic business owner may isolate the source of performance and availability problems as they occur so that these problems can be corrected before they produce expensive outages and lost revenue.

TMTP links user transactions and sub-transactions using correlating tokens, such as ARM (Application Response Measurement) correlators. ARM is a standard for measuring response time and status of transactions. ARM employs an ARM engine, which records response time measurements of the transactions. TMTP employs management agents, which run on associated monitored servers, to record transaction status, response time, and any other measurements of the transactions. The TMTP Management Agent incorporates an ARM engine to record transaction status and response time. For example, in order to measure a response time, an application invokes a ‘start’ method using ARM, which creates a transaction instance to capture and save a timestamp. After the transaction ends, the application invokes a ‘stop’ method using ARM to capture a stop time. The difference between a start and stop time is the response time of the transaction. More information regarding the manner by which the TMTP system collects performance data, stores it, and uses it to generate reports and transaction graph data structures may be obtained from the Application Response Measurement (ARM) Specification, version 4.0, which is hereby incorporated by reference.

TMTP passes correlating tokens in user transactions to allow for monitoring the progress of the user transactions through the system. As an initiator of a transaction may invoke a component within an application and this invoked component can in turn invoke another component within the application, correlating tokens are used to “tie” these transactions together.

In addition to ARM correlators, TMTP also leverages a programming technique, known as aspect-oriented programming (AOP), for defining start and stop methods of the transactions in order to measure performance. Aspect oriented programming techniques allow programmers to modularize crosscutting concerns by encapsulating behaviors that affect multiple classes into reusable modules. In TMTP, aspect-oriented programming technique, such as just-in-time-instrumentation (JITI), is employed to weave response time and other measurement operations into applications for monitoring performance.

In today's complex enterprise environments, Web-based transactions typically span multiple servers. A request will usually travel from a Web server, to a cluster of Java 2 Platform Enterprise Edition (J2EE) servers, to a database and probably to a back-end Enterprise Information System (EIS) system like Customer Information Control System (CICS), a product of International Business Machines Corporation. However, if any step in a complex transaction performs poorly or is unavailable, it is possible that the entire transaction will fail. The end user may spend an excessive amount of time waiting to receive a response from the requested page, wherein the time is spent waiting for connections to timeout somewhere in the enterprise back-end, be it waiting on an unavailable server or overloaded database connection. These long waits experienced by the end user ultimately result in an error page being rendered or a ‘page not found’ exception.

When monitoring Web-based applications, the end goal is to optimize transaction response times and availability. When an end user visits a company's website, the end user expects the website to be available and respond quickly. Most analysts estimate that an end user will only wait about eight seconds for a Web page to respond. TMTP allows system administrators to define performance thresholds, which are limits of performance that are acceptable for a transaction response. For example, an administrator may define a threshold of response time, which is the highest number of seconds a transaction may take. If the response time measured exceeds the threshold, TMTP alerts the system administrator of the performance problem. However, as these alerts are usually in the form of an email or forwarded event notification, these alerts merely notify the administrator that there is a problem with the performance of a transaction.

Therefore, it would be advantageous to have a mechanism for providing and executing a corrective action on any monitored server in an enterprise to correct a performance issue identified on a particular server using existing transaction performance monitoring processes, including detecting threshold violations.

### SUMMARY OF THE INVENTION

The present invention provides a method, system, and computer program instructions for using existing performance monitoring solutions to detect performance issues in an enterprise, and providing and executing a corrective action on any server being monitored in the enterprise to correct the performance issue. When a management agent on a monitored server detects a threshold violation, the management agent sends a violation event to the management server. Upon receiving the violation event, the management server distributes a corrective action associated with the threshold violation to all defined management agents involved in the transaction. Each management agent then runs the corrective action to remedy the performance problem.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a distributed data processing system in which the present invention may be implemented;

FIG. 2 is an exemplary diagram of a server computing device which may be used to send transactions to elements of the present invention;

FIG. 3 is an exemplary diagram of a client computing device upon which elements of the present invention may be implemented;

FIG. 4 is a conceptual diagram of an electronic business system in accordance with the present invention;

FIG. 5 is a diagram illustrating interactions between components for executing a corrective action on any server being monitored in an enterprise in accordance with a preferred embodiment; and

FIG. 6 is a flowchart outlining an exemplary operation for executing a corrective action on any server being monitored in an enterprise in accordance with a preferred embodiment of the present invention.

### DETAILED DESCRIPTION OF THE PREFERRED EMBODIMENT

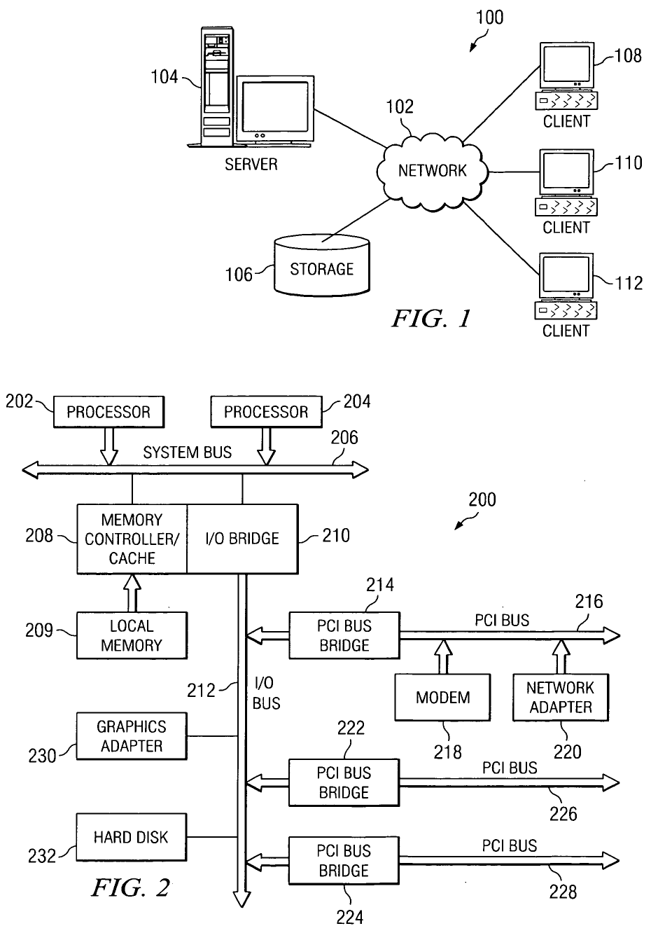

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, New York, running the Advanced Interactive Executive (AIX) operating system or LINUX operating system.

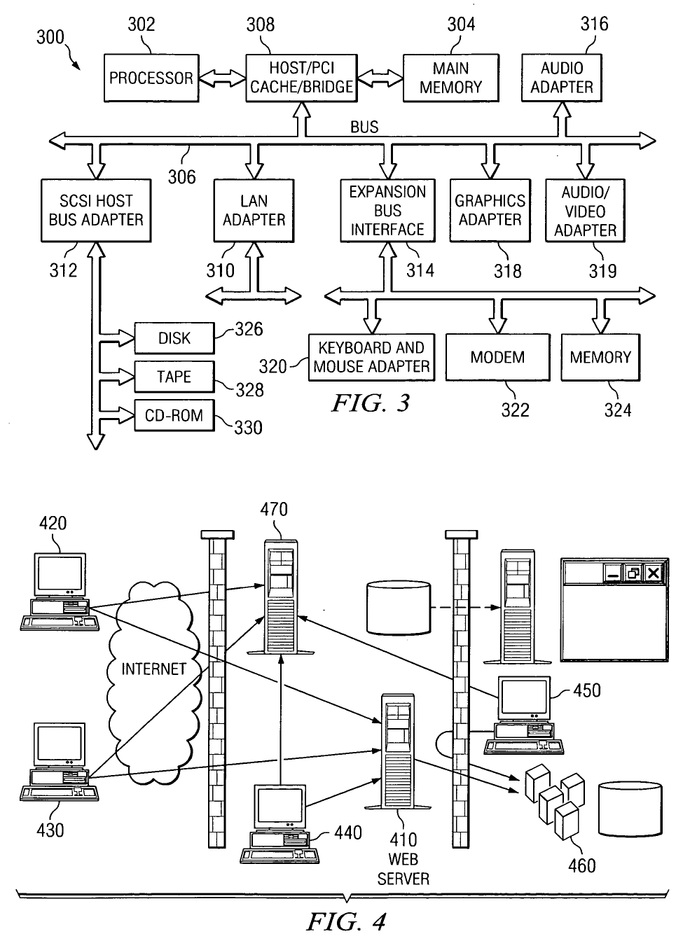

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

One or more servers, such as server 104, may provide Web services of an electronic business for access by client devices, such as clients 108, 110 and 112. With the present invention, a performance monitoring system is provided for monitoring performance of components of the Web server and its enterprise back end systems in order to provide data representative of the enterprise business' performance in handling transactions. In one exemplary embodiment of the present invention, this performance monitoring system is IBM Tivoli Monitoring for Transaction Performance™ (TMTP) which measures and compiles transaction performance data including transaction processing times for various components within the enterprise system, error messages generated, and the like.

The present invention provides a new type of response to an event in the form of a corrective action. As mentioned previously, the present invention provides a means for executing a corrective action event response using a performance monitoring application to correct an identified performance problem. The present invention builds upon existing performance monitoring systems that detect performance issues in an enterprise and provides a new type of event response not found in the current art. This new event response type includes corrective actions that may be performed on any of the monitored servers in the enterprise.

With the present invention, a system administrator is allowed to associate corrective action event responses with threshold violations using a performance monitoring application. A system administrator may define a performance threshold, which is a limit of performance that is acceptable to the company. For example, a system administrator may define a threshold of response time, which is the highest number of seconds a transaction may take. In existing systems, when a performance threshold violation is detected, the management server issues an event response in the form of an email alert. When the system administrator receives this email alert, the administrator subsequently may take steps to fix the performance issue. In contrast, with the mechanism of the present invention, when a defined threshold is violated, the management server distributes a corrective action to each of the management agents involved in the transaction in order to correct the detected performance problem. The user defines the set of management agents that will receive the corrective action based on the type of violation event received by the management server. By distributing the corrective action to a defined set of the management agents, the performance issue on the particular server that recorded the violation may be remedied, as well as predicting that the performance issue may occur on other servers involved in the transaction as well.

In particular, a system administrator configures monitoring policies, performance thresholds, and event responses on a centralized management server. Management agents are run on monitored servers in the enterprise to record performance information for each server. When a performance threshold violation is detected in a subtransaction, an event is generated by the management agent that is running on the specific server resource that services the subtransaction. The subtransaction is just one of many correlated steps in the overall distributed transaction. The management agent is able to detect the specific location of the performance threshold violation. The thresholds that are defined are linked to a monitoring policy that is distributed to all monitored servers running the transactions. The event that is generated due to the threshold violation contains the policy information as well as the server name that caused the violation. The management agent sends the event to a centralized management server that is responsible for collecting and interpreting all monitoring data.

When the event sent by the management agent is received at the management server, a defined event response, or corrective action, is triggered based on the particular violation. As the corrective action mechanism is generic enough to allow for any action to be performed on any of the monitored servers, unique corrective actions may be taken due to different violations occurring on different servers or with different subtransaction name/types. This flexibility is crucial when defining a generic event response system. The management server sends the corrective action to the management agents running on a defined set of associated monitored servers. The user may define the set of monitored servers by associating a list of management agents and corrective actions for a particular violation event. Each management agent in the defined set of management agents then runs the corrective action to help remedy the transaction performance problem. In this manner, the particular performance issue may be corrected.

One specific example of an event response/corrective action may be used to remedy excessive wait times a user may experience when waiting for a page response. These excessive wait times may occur when waiting for connections to timeout somewhere in the enterprise backend, be it waiting on an unavailable server or overloaded database connection. When monitoring transactions, the mechanism of the present invention may allow for redirecting transactions based on transaction response time policies in the distributed environment. The system administrator may configure an event response so that when a subtransaction for a particular policy violates a defined threshold, the event response notifies the policy's edge transaction, the first location in the monitored application where a transaction is recorded by the monitoring application, to begin redirecting all new incoming requests for that policy's transaction. This corrective action would essentially redirect an end user away from their desired transaction to a new transaction. The new transaction could be an error page or some other alternative page with a different functionality. For instance, if a backend performance problem is encountered, the mechanism of the present invention allows for quickly redirecting a user to another transaction path or to an error page, which allows for reducing the load on the backend systems, giving them time to disperse any back log and reduce their request queues. Other examples of event responses/corrective actions that may be distributed to the defined set of management agents include stopping and starting a process, invoking a remote script or command, modifying a monitored application configuration, or modifying an operating system configuration.

The event response may also be configured to provide a throttling control, so that only a portion of incoming requests are redirected and the remainder of the requests continue as normal. This throttling control may act as a type of load balancing that would alleviate any back-end overload. For example, a certain percentage of incoming requests, say 80%, may be redirected to an alternative path or an error page, while the remaining 20% of incoming requests are processed normally. Thus, while some of the requests may be redirected to an alternative path, other requests are allowed to be processed by the backend systems. When it is determined by monitoring the processed requests that the load is balanced on the backend systems, the throttling controls may be reduced or eliminated.

Turning now to FIG. 4, an exemplary diagram of an electronic business system in accordance with a known transaction performance monitoring architecture is shown. Client devices 420-450 may communicate with Web server 410 in order to obtain access to services provided by the back-end enterprise computing system resources 460. Transaction performance monitoring system 470 is provided for monitoring the processing of transactions by the Web server 410 and enterprise computing system resources 460.

Web server 410, enterprise computing system resources 460 and transaction performance monitoring system 470 are part of an enterprise system. Client devices 420-450 may submit requests to the enterprise system via Web server 410, causing transactions to be created. The transactions are processed by Web server 410 and enterprise computing system resources 460 with transaction performance monitoring system 470 monitoring the performance of Web server 410 and enterprise computing system resources 460 as they process the transactions.

This performance monitoring involves collecting and storing data regarding performance parameters of the various components of Web server 410 and enterprise computing system resources 460. For example, monitoring of performance may involve collecting and storing information regarding the amount of time a particular component spends processing the transaction, a SQL query, component information including class name and instance id in the JAVA Virtual Machine (JVM), memory usage statistics, any properties of the state of the JVM, properties of the components of the JVM, and/or properties of the system in general.

The components of Web server 410 and enterprise computing system resources 460 may include both hardware and software components. For example, the components may include host systems, JAVA Server Pages, servlets, entity beans, Enterprise Java Beans, data connections, and the like. Each component may have its own set of performance characteristics which may be collected and stored by transaction performance monitoring system 470 in order to obtain an indication as to how the enterprise system is handling transactions.

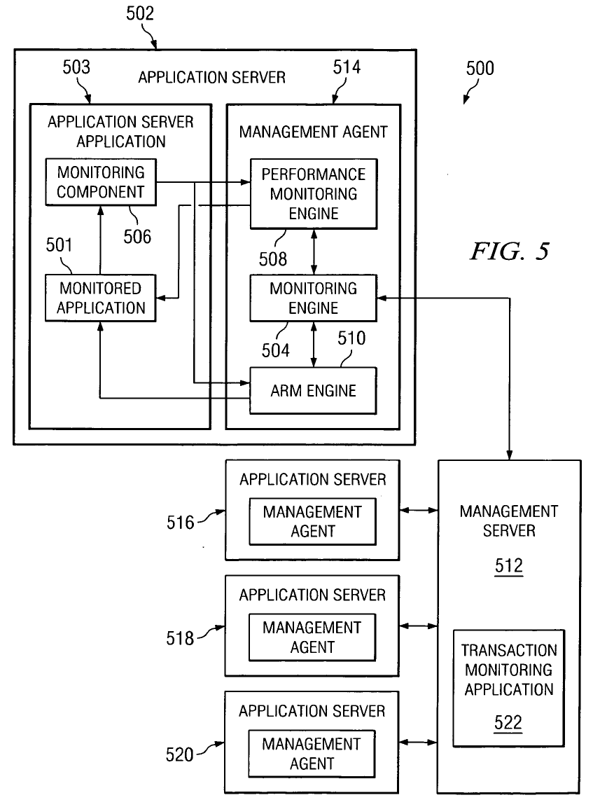

Turning now to FIG. 5, a diagram illustrating primary operational components for executing a corrective action on any server being monitored in an enterprise is depicted in accordance with a preferred embodiment. As depicted in FIG. 5, in this example implementation, within performance monitoring environment 500, monitored application 501 resides on application server 502. Application server 502 may be implemented using application server application 503, such as a WebSphere Application Server available from International Business Machines Corporation, or a Microsoft NET platform, a product available from Microsoft Corporation.

Transaction performance monitoring application 522 is located within management server 512. A system administrator configures transaction performance monitoring application 522 to define a monitoring policy for transactions occurring within performance monitoring environment 500. The system administrator also defines acceptable threshold levels for the subtransactions. Once the monitoring policy and threshold levels are defined, the system administrator then assigns a corrective action event response for each threshold, wherein the corrective action event response associated with a threshold is automatically triggered when a violation of that threshold is detected.

In a preferred embodiment, monitoring engine 504, performance monitoring engine 508 and ARM engine 510 are implemented as part of management agent 514. Management agent 514 is a mechanism distributed among different servers within performance monitoring environment 500, including application servers 502, 516, 518, and 520, for matching defined policies to the transactions. In addition, when the system administrator updates the policy and threshold information in transaction monitoring application 520, management server 512 sends the updated information to each management agent in performance monitoring environment 500. When the monitoring engine in a management agent, such as monitoring engine 504 in application server 502 receives the updated policy or threshold information, monitoring engine 504 in turn notifies either performance monitoring engine 508 if the thresholds are based on resource measurements, or ARM engine 510 if the thresholds are based on transaction monitoring.

For instance, at run time, monitored application 501 runs the monitored transaction and monitoring component 506 generates the transaction by intercepting the call and invoking a ‘start’ method on performance monitoring engine 508 or ‘ARM_start’ method on ARM engine 510. Performance monitoring engine 508 or ARM engine 510 then matches the transaction via monitoring engine 508 against defined policies in monitoring engine 504 to see if the transaction is defined in a policy. If the transaction is defined, meaning that monitored application 501 is being monitored, monitoring engine 504 notifies ARM engine 510 or performance monitoring engine 508 to measure the performance of the transaction.

If management agent 514 detects that a threshold violation has occurred, ARM engine 510 or performance monitoring engine 508 automatically sends a violation event to management server 512. Upon receiving the violation event, management server 512 identifies the corrective action associated with the violation event, and sends the corrective action response to management agent 514. Management server 512 also sends the corrective action response a defined set of management agents capable of affecting the transaction, such as management agents 516, 518, and 520. Each management agent then runs the corrective action to remedy the performance problem.

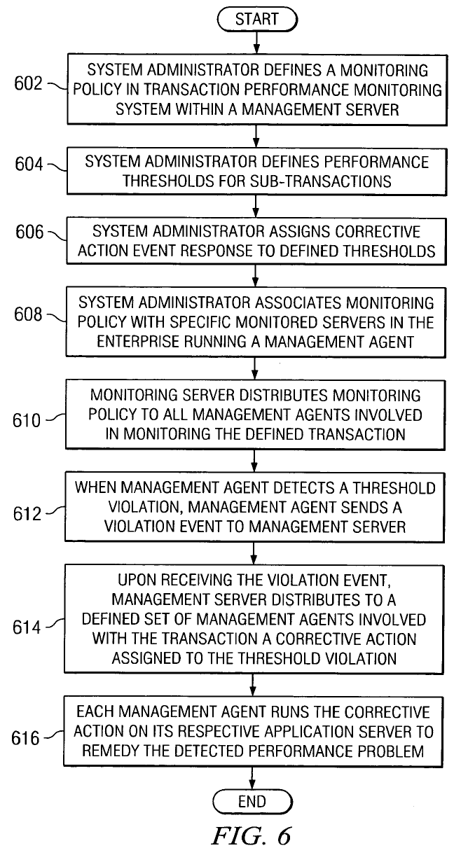

Turning now to FIG. 6, a flowchart outlining an exemplary process for executing a corrective action on any server being monitored in an enterprise is shown in accordance with a preferred embodiment of the present invention. The process illustrated in FIG. 6 may be implemented in a data processing system, such as data processing system 200 in FIG. 2. In this illustrative example, a transaction performance monitoring system is used to associate event responses with transaction threshold violations.

The process begins with a system administrator defining a monitoring policy in a transaction performance monitoring system within a management server (step 602). The monitoring policy defines which transactions should be recorded. Based on the policy, the transaction performance monitor may dynamically include or exclude components in the transaction model based on the transaction instance. The system administrator also defines performance thresholds for the subtransactions (step 604). For example, a threshold may be defined as an acceptable response time, which is the highest number of seconds a transaction may take. In step 606, the system administrator then assigns a corrective action event response to the threshold defined in step 604. This new type of event response is in the form of a corrective action, which is executed when a threshold violation is detected. The event response may also be configured to provide a throttling control, such that only a portion of incoming requests are redirected and the remainder of the requests continue as normal. The throttling control will act as a type of load balancing that would alleviate any back-end overload.

Next, the system administrator may associate the monitoring policy with specific monitored servers in the enterprise that are running a management agent (step 608). The monitoring policy is then distributed to all management agents involved in monitoring the defined transaction (step 610). The management agents monitor and record the transactions times to determine if a threshold is violated based on the distributed policy.

When a management agent on a monitored server detects a threshold violation at a specific location on the monitored server, the management agent sends a violation event corresponding to that specific location to the management server (step 612). Upon receiving the violation event, an event listener on the management server is fired, and the corrective action assigned to the threshold violation is distributed to all of the defined management agents capable of affecting the transaction (step 614). In this manner, when a performance threshold violation is detected at any point in a transaction, a corrective action may be taken at any point upstream or downstream in the transaction. Each management agent runs the corrective action on its respective application server to remedy the detected performance problem (step 616). For example, a corrective action may be reconfiguring the load balancing on a web server to redirect the transaction to a predefined alternate path. Thus, the event response may notify the policy's edge transaction to begin redirecting all new incoming requests for that policy's transaction. This alternate path may be an error page or another page with different functionality. The corrective action may also be modifying a monitored application configuration or an operating system configuration, stopping and starting a process, or invoking a remote script or command, for example.

Thus, the present invention provides a method, apparatus, and computer instructions for redirecting transactions based on transaction response time policies in a distributed environment. The present invention provides an advantage over current transaction monitoring systems by providing new and improved functionality that allows for executing a corrective action on any server being monitored in an enterprise using a performance monitoring application. These corrective actions are used not only to notify the system administrator that a performance issue has occurred, but also to correct the performance problem on any of the monitored servers in the enterprise. In this manner, problems related to availability and performance in a distributed environment may be detected and addressed in order to ease any back-end overload.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing event responses, comprising:
receiving, at a management server, a violation event from a management agent on a monitored server, wherein the violation event represents a threshold violation at a specific location on the monitored server;
identifying a defined set of management agents based on the violation event received; and
distributing a corrective action to the defined set of management agents responsive to receiving the violation event, wherein the corrective action is associated with the threshold violation, and wherein each management agent in the defined set of management agents runs the corrective action on its respective monitored server to remedy a performance problem.

2. The method of claim 1, wherein the management server defines a monitoring policy in a performance monitoring system; assigns a corrective action to a performance threshold associated with the monitoring policy; associates a monitoring policy with monitored servers running a management agent; and distributes the monitoring policy to the defined set of management agents, wherein each management agent in the defined set of management agents is used to detect if a threshold is violated based on the monitoring policy.

3. The method of claim 1, wherein the set of management agents to receive the corrective action based on the violation event is user-defined.

4. The method of claim 1, wherein the corrective action includes one of stopping and starting a process, invoking a remote script or command, modifying a monitored application configuration, and modifying an operating system configuration.

5. The method of claim 1, wherein the corrective action includes redirecting an incoming request from a desired transaction to a predefined alternate transaction.

6. The method of claim 5, wherein the corrective action is configured as a throttling control, wherein a portion of incoming requests are redirected to the predefined alternate transaction and remaining incoming requests are processed in a normal manner.

7. The method of claim 5, wherein the predefined alternate transaction includes an error page.

8. The method of claim 5, wherein the predefined alternate transaction includes a page with a different functionality than the desired transaction.

9. The method of claim 1, wherein the corrective action notifies an edge transaction in a monitoring policy to begin redirecting all new incoming requests for a transaction.

10. The method of claim 1, wherein the corrective action runs on any monitored server upstream or downstream in a transaction.

11. The method of claim 2, wherein the performance threshold is an acceptable response time.

12. A system for managing event responses in a distributed network environment, comprising:
a management server; and
a defined set of management agents connected to the management server, wherein a management agent in the defined set of management agents detects a threshold violation at a specific location on a monitored server and sends a violation event to the management server;
wherein an association between the violation event and a corrective action is defined on the management server;
wherein the management server identifies the defined set of management agents based on the violation event received and distributes the corrective action to the defined set of management agents; and
wherein each management agent in the defined set of management agents runs the corrective action on its respective monitored server to remedy a performance problem.

13. The system of claim 12, wherein the management server defines a monitoring policy in a performance monitoring system; assigns a corrective action to a performance threshold associated with the monitoring policy; associates a monitoring policy with monitored servers running a management agent; and distributes the monitoring policy to the defined set of management agents, wherein each management agent in the defined set of management agents is used to detect if a threshold is violated based on the monitoring policy.

14. The system of claim 12, wherein the set of management agents to receive the corrective action based on the violation event is user-defined.

15. The system of claim 12, wherein the corrective action includes one of stopping and starting a process, invoking a remote script or command, modifying a monitored application configuration, and modifying an operating system configuration.

16. The system of claim 12, wherein the corrective action includes redirecting an incoming request from a desired transaction to a predefined alternate transaction.

17. The system of claim 16, wherein the corrective action is configured as a throttling control, wherein a portion of incoming requests are redirected to the predefined alternate transaction and remaining incoming requests are processed in a normal manner.

18. The system of claim 16, wherein the predefined alternate transaction includes an error page.

19. The system of claim 16, wherein the predefined alternate transaction includes a page with a different functionality than the desired transaction.

20. The system of claim 12, wherein the corrective action notifies an edge transaction in a monitoring policy to begin redirecting all new incoming requests for a transaction.

21. The system of claim 12, wherein the corrective action runs on any monitored server upstream or downstream in a transaction.

22. The system of claim 13, wherein the performance threshold is an acceptable response time.

23. The system of claim 12, wherein the management server is located in a data processing system.

24. The system of claim 12, wherein the defined set of management agents are located in a plurality of data processing systems.

25. A computer program product in a computer readable medium for managing event responses, comprising:
first instructions for receiving, at a management server, a violation event detected by a management agent on a monitored server, wherein the violation event represents a threshold violation at a specific location on the monitored server;
second instructions for identifying a defined set of management agents based on the violation event received; and
third instructions for distributing a corrective action to the defined set of management agents responsive to receiving the violation event, wherein the corrective action is associated with the threshold violation, and wherein each management agent in the defined set of management agents runs the corrective action on its respective monitored server to remedy a performance problem.

26. The computer program product of claim 25, wherein the management server defines a monitoring policy in a performance monitoring system; assigns a corrective action to a performance threshold associated with the monitoring policy; associates a monitoring policy with monitored servers running a management agent; and distributes the monitoring policy to the defined set of management agents, wherein each management agent in the defined set of management agents is used to detect if a threshold is violated based on the monitoring policy.

27. The computer program product of claim 25, wherein the set of management agents to receive the corrective action based on the violation event is user-defined.

28. The computer program product of claim 25, wherein the corrective action includes one of stopping and starting a process, invoking a remote script or command, modifying a monitored application configuration, and modifying an operating system configuration.

29. The computer program product of claim 25, wherein the corrective action includes redirecting an incoming request from a desired transaction to a predefined alternate transaction.

30. The computer program product of claim 29, wherein the corrective action is configured as a throttling control, wherein a portion of incoming requests are redirected to the predefined alternate transaction and remaining incoming requests are processed in a normal manner.

31. The computer program product of claim 29, wherein the predefined alternate transaction includes an error page.

32. The computer program product of claim 29, wherein the predefined alternate transaction includes a page with a different functionality than the desired transaction.

33. The computer program product of claim 25, wherein the corrective action notifies an edge transaction in a monitoring policy to begin redirecting all new incoming requests for a transaction.

34. The computer program product of claim 25, wherein the corrective action runs on any monitored server upstream or downstream in a transaction.

35. The computer program product of claim 24, wherein the performance threshold is an acceptable response time.
